(19) United States
(12) Patent Application Publication
(10) Pub. No.: US 2005/0011870 A1
(43) Pub. Date: Jan. 20, 2005

(54) Process for welding metal bodies

(75) Inventors: Ralf Bernhardt, Leonberg (DE); Tobias Hiermer, Sindelfingen (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLERCHRYSLER AG, STUTTGART (DE)

(21) Appl. No.: 10/854,758

(22) Filed: May 27, 2004

(30) Foreign Application Priority Data
May 28, 2003 (DE) 103 24 274.0

(51) Int. Cl. B23K 26/24

(52) U.S. Cl. 219/121.64

(57) ABSTRACT

The invention relates to a process for welding metal bodies with a coated surface by means of laser welding, in which the coating of the surface is incorporated in a weld seam formed during the welding. A laser beam is passed over the same weld seam a number of times. In the process, the weld seam is melted a number of times, at least in regions.

### BACKGROUND AND SUMMARY OF THE INVENTION

This application claims the priority of German Patent Application No. 103 24 274.0, filed May 28, 2003, the disclosure of which is expressly incorporated by reference herein.

The invention relates to a process for welding metal bodies with a coated surface by means of laser welding, in which the coating of the surface is incorporated in a weld seam formed during the welding.

It is known to join metal bodies by means of laser welding. In this process, a laser beam is passed slowly over, for example, a joining location between two metal bodies. The joining location is melted and, once it has solidified, forms a weld seam which cohesively joins the metal bodies. In the case of coated metal bodies, the material of the coating can be incorporated into the weld seam, where it can form regions which may be enriched with constituents of the coating.

A laser welding process of this type is described, for example, in U.S. Pat. No. 4,940,878. In that document, copper sheets which are coated with nickel are stacked on top of one another and welded using a laser beam being passed slowly, in lines, over the surface, so that parallel weld seams are produced. The nickel forms an alloy with the copper in the weld seam, thus forming a welded composite body having an anisotropic electrical conductivity. The electrical conductivity of the copper is higher parallel to the linear weld seams, which are formed by a copper-nickel alloy, than perpendicular thereto. The thickness of the nickel coating must be set in such a way that there is sufficient material to fully alloy the weld zone down to a sufficient depth. The composite body can be used, for example, for low-loss rotors of electrical machines.

However, the performance of the material components in the weld seam is material-specific. For example, coatings of metal bodies which are to be welded together tend to form disruptions in the weld microstructure that are undesirable. This applies in particular to metal sheets which are covered with only a thin protective layer and in which constituents of the coating are not actually intended to play any role in the weld seam.

It is an object of the invention to provide a process for welding metal bodies which is suitable for welding metal bodies coated with aluminium or aluminium alloys.

This and other objects and advantages are achieved by a process for welding metal bodies according to the invention. In an embodiment, the invention comprises a process for welding metal bodies with a coated surface by means of laser welding, in which the coating of the surface is incorporated in a weld seam formed during the welding. In such an embodiment, a laser beam is passed over a weld seam of a coated metal body a number of times, and at least a portion of the weld seam is melted a number of times. One advantage is that a virtually homogeneous microstructural mixture is produced. The quality of the weld seam is not adversely affected. All of the alloying components are distributed, and it is possible for solid solutions to form in the weld microstructure. The strength of the weld seam may increase. Regions in which constituents of the coating have or could have become enriched or_concentrated are instead dissolved and disappear.

Further advantages and configurations of the invention are to be taken from the embodiments provided in the description and the further claims.

### BRIEF DESCRIPTION OF THE DRAWINGS

The invention is explained in more detail below with reference to the figures, in which:

FIG. 1 shows a transverse microsection through a weld zone of a coated metal body having a region enriched with coating material, and

FIG. 2 shows a transverse microsection through a weld seam which has been treated in accordance with the invention.

In the process according to an embodiment of the invention for welding coated metal bodies by means of laser welding, the coating of the surface is incorporated into a weld seam formed during the welding. Given suitable combinations of materials in the metal body and coating or constituents of the coating, it is possible for metallurgical notches which are enriched with constituents of the coating to form in the weld seam.

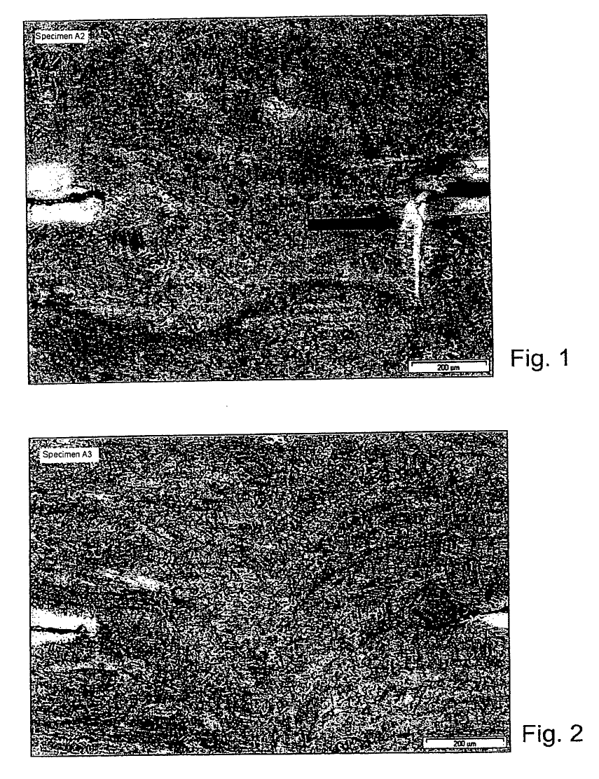

A weld seam of this type in a laser-welded metal sheet is illustrated in FIG. 1. The weld seam is arranged in a preferred metal body made from a boron-containing steel, preferably a steel comprising the main components Fe, C, Mn, B, preferably with an Mn/B ratio corresponding to 22MnB5, particularly preferably a metal body made from USIBOR 1500 P. The metal body is provided with a preferred coating of AlSi. A metallurgical notch is indicated by an arrow in the right-hand half of the figure. Metallurgical phases of Al, Si and Fe are present in the notch. Al and Si are introduced into the weld seam during welding.

According to an embodiment of the invention, a laser beam is passed over the same weld seam a number of times—for example with the aid of scanner optics. In the process the weld seam is melted a number of times, at least in regions. In this embodiment, in contrast to conventional welding procedures, the same weld seam is melted a number of times. This has the advantageous result that constituents of the coating in the region of the weld seam are alloyed into a molten material in the weld seam during the repeated melting. As a result, the metallurgical notches disappear and the material is finely distributed.

In an embodiment, the melting is carried out sufficiently often for constituents of the coating which have been introduced into the weld seam to be substantially incorporated in an alloy in the region of the weld seam and for metallurgical notches to have disappeared.

In another embodiment, the laser beam is passed over the weld seam at least twice and at most four times, and the weld seam is melted the same number of times. It has proven particularly advantageous for the laser beam to be passed over the weld seam three times and for the weld seam accordingly to be melted three times.

FIG. 2 shows a transverse microsection through a coated metal body which has been treated in accordance with the invention. In this case, the metal body is an AlSi-coated metal sheet made from USIBOR 1500 P. With the preferred combination of an aluminized boron-containing steel sheet aluminized with AlSi, the repeated melting is achieved without any loss in quality. The microstructure of the weld seam, which has been scanned and melted a total of three times with a laser beam, is homogeneous and there is no longer any evidence of disruptions to the microstructure in the form of metallurgical notches.

It is particularly expedient for repeated, in particular triple, melting to be provided for using a scanner program in a laser beam control, so that the duration and number of melting operations can be executed with accuracy.

It has been found that repeated melting with the laser beam does not have any adverse effects on the strength of the weld seam. The fine distribution of all of the alloying components of metal body and coating, or of the constituents of the coating, leads to the formation of a solid solution in the weld microstructure, which may even increase the strength in addition to eliminating the metallurgical notches.

In an embodiment, the process according to the invention is particularly suitable for aluminized, in particular hot-dip aluminized metal sheets. It is advantageous for the process according to the invention to be applied to metal sheets formed from USIBOR 1500 P which have been hot-dip aluminized. It is particularly preferable for the metal sheets to be hot-dip aluminized with a coating formed from a silicon-containing aluminium alloy, in particular AlSi.

The use of such hot-dip aluminized metal sheets which have been laser-welded according to the invention in a vehicle body is particularly expedient. It is particularly preferable for metal sheets of this type which have been welded in accordance with the invention to be used as B pillars. This advantageously results in vehicle body components which have been protected against corrosion and have high-quality weld seams.

Although the present invention has been illustrated and described with respect to exemplary embodiment thereof, it should be understood by those skilled in the art that the foregoing and various other changes, omission and additions may be made therein and thereto, without departing from the spirit and scope of the present invention. Therefore, the present invention should not be understood as limited to the specific embodiment set out above but to include all possible embodiments which can be embodied within a scope encompassed and equivalent thereof with respect to the feature set out in the appended claims.

1. A process for welding metal bodies with a coated surface by laser welding, comprising:
melting one or more regions of a weld seam between metal bodies two or more times by passing a laser beam over the weld seam a plurality of times,
wherein a coating of at least one of the metal bodies is incorporated into the weld seam.

2. A process according to claim 1, wherein constituents of the coating incorporated into the weld seam are alloyed into a molten material during the melting.

3. A process according to claim 1, wherein based on a frequency of the melting, constituents of the coating are substantially incorporated in an alloy in the region of the weld seam during the melting.

4. A process according to claim 1, wherein the laser beam is passed over the weld seam at least twice and at most four times, and the weld seam is melted the same number of times.

5. A process according to claim 4, wherein the laser beam is passed over the weld seam three times.

6. A process according to claim 1, wherein at least one of the metal bodies comprises a boron-containing steel.

7. A process according to claim 6, wherein the at least one metal body comprises a metal sheet, the main constituents of which are Fe, C, Mn, B.

8. A process according to claim 1, wherein the coating comprises aluminium or an aluminium alloy.

9. A process according to claim 8, wherein the coating is an AlSi alloy.

10. A process for making a component of a vehicle body, comprising making the component using the process of claim 1.

11. A process for welding metal bodies with a coated surface by laser welding, comprising:
forming a weld seam between metal bodies by laser welding, at least one of the metal bodies having a coated surface; and
melting at least a portion of the weld seam one or more times by passing a laser beam over the weld seam one or more times,
wherein a coating of the coated surface is incorporated into the weld seam.
